(19) United States
(12) Patent Application Publication
(10) Pub. No.: US 2021/0129220 A1
(43) Pub. Date: May 6, 2021

(54) Method and Apparatus for In Situ Synthesis of Alloys and/or Composites From Different Composition Powders During Additive Manufacturing

(71) Applicant: Jian Liu, Saratoga, CA (US)

(72) Inventor: Jian Liu, Saratoga, CA (US)

(73) Assignee: PolarOnyx, Inc., San Jose, CA (US)

(21) Appl. No.: 16/669,507

(22) Filed: Oct. 30, 2019

(51) Int. Cl. B22F 3/105

(52) U.S. Cl. CPC B22F 3/1055; B22F 2003/1057; B22F 2302/10; B33Y 80/00; B22F 2302/35; B22F 2302/05; B22F 2302/256

(57) ABSTRACT

Methods and apparatuses for in situ synthesis of alloys and/or composites are disclosed, the method comprising: (a) providing an apparatus having: an electromagnetic energy source; an autofocusing scanner; a powder system; a powder delivery system; and computers coupled and configured to control the electromagnetic energy source, the autofocusing scanner, the powder system, and the powder delivery system; (b) programming the computers with structural and material specifications of the sample; (c) using the computers to control electromagnetic radiation, powder mixture, and powder deposition parameters; and (d) focusing and scanning the electromagnetic radiation onto the sample while two or more powders are concurrently deposited onto the sample to deposit layers onto the sample for multiple metal powder synthesis, metal and ceramic synthesis, ceramic synthesis, and/or gradated composition synthesis, wherein the layers comprise at least one new material which differs from the two or more powders. Other embodiments are described and claimed.

### I. STATEMENT REGARDING FEDERALLY SPONSORED RESEARCH

The U.S. Government has a paid-up license in this invention and the right in limited circumstances to require the patent owner to license others on reasonable terms as provided for by the terms of the Department of Energy contract numbers DE-SC0019721, DE-SC0018602, and DE-SC0019860 and NASA SBIR contract numbers 80NSSC18C0110 and 80NSSC19C0268.

### II. BACKGROUND

The invention relates generally to the field of three-dimensional additive manufacturing systems. More particularly, the invention relates to a method and apparatus for in situ synthesis of alloys and/or composites, such as ceramic or metal matrix composites, using different composition powders during the process of three-dimensional additive manufacturing.

### III. SUMMARY

In one respect, disclosed is a method for in situ synthesis of alloys and/or composites from two or more powders in additive manufacturing comprising: (a) providing an apparatus having: an electromagnetic energy source configured to generate electromagnetic radiation; an autofocusing scanner configured to receive the electromagnetic radiation from the electromagnetic energy source and to focus and scan the electromagnetic radiation onto a stage where a sample is additively manufactured; a powder system comprising N powder vessels for the two or more powders; a powder delivery system configured to receive the two or more powders from the powder system and to deposit the two or more powders onto the stage in the vicinity of the focused and scanned electromagnetic radiation; and one or more computers coupled to the electromagnetic energy source, the autofocusing scanner, the powder system, and the powder delivery system and configured to control the electromagnetic energy source, the autofocusing scanner, the powder system, and the powder delivery system; (b) programming the one or more computers with structural and material specifications of the sample to be additively manufactured; (c) using the one or more computers to control electromagnetic radiation, powder mixture, and powder deposition parameters based on the structural and material specifications of the sample programmed into the one or more computers; and (d) using the autofocusing scanner to focus and scan the electromagnetic radiation onto the sample while the two or more powders are concurrently deposited by the powder delivery system onto the sample in order to deposit one or more layers onto the sample for multiple metal powder synthesis, metal and ceramic synthesis, ceramic synthesis, and/or gradated composition synthesis, wherein the one or more layers comprise at least one new material which differs from the two or more powders.

In another respect, disclosed is an apparatus for in situ synthesis of alloys and/or composites using two or more powders in additive manufacturing comprising: an electromagnetic energy source configured to generate electromagnetic radiation; an autofocusing scanner configured to receive the electromagnetic radiation from the electromagnetic energy source and to focus and scan the electromagnetic radiation onto a stage where a sample is additively manufactured; a powder system comprising N powder vessels for the two or more powders; a powder delivery system configured to receive the two or more powders from the powder system and to deposit the two or more powders onto the stage in the vicinity of the focused and scanned electromagnetic radiation; and one or more computers coupled to the electromagnetic energy source, the autofocusing scanner, the powder system, and the powder delivery system and configured to control the electromagnetic energy source, the autofocusing scanner, the powder system, and the powder delivery system to deposit one or more layers of the sample for multiple metal powder synthesis, metal and ceramic synthesis, ceramic synthesis, and/or gradated composition synthesis, wherein the one or more layers comprise at least one new material which differs from the two or more powders.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a schematic illustration of an apparatus for in situ synthesis of alloys and/or composites using different composition powders during three-dimensional additive manufacturing, in accordance with some embodiments.

FIG. 2 shows an electron backscatter diffraction of an additively manufactured sample from multiple metal powder synthesis using the apparatus for in situ synthesis of alloys and/or composites of FIG. 1, in accordance with some embodiments.

FIGS. 3A and 3B show scanning electron microscopy images and energy-dispersive X-ray spectroscopy composition spectrums of additively manufactured samples using in situ metal and ceramic synthesis of alloys and composites of aluminum/boron carbon powder mixture and tungsten/hafnium tantalum carbide powder mixture, respectively, in accordance with some embodiments.

FIGS. 4A and 4B show additively manufactured sample parts using in situ metal and ceramic synthesis of alloys and composites of aluminum/boron carbon powder mixture and tungsten/hafnium tantalum carbide powder mixture, respectively, in accordance with some embodiments.

FIGS. 5A and 5B show X-ray powder diffraction data of additively manufactured sample parts using in situ metal and ceramic synthesis of alloys and composites of aluminum/boron carbon powder mixture and tungsten/hafnium tantalum carbide powder mixture, respectively, using the apparatus of FIG. 1, in accordance with some embodiments.

FIG. 6 shows a phase transition diagram of titanium and aluminum, in accordance with some embodiments.

FIG. 7 is a schematic illustration of an integral heat pipe with gradated composition, in accordance with some embodiments.

FIG. 8 is a schematic illustration of gradated layer area formed between tungsten and copper, in accordance with some embodiments.

FIG. 9 is a block diagram illustrating a method for in situ synthesis of alloys and/or composites using different composition powders in three-dimensional manufacturing, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Current tools and technologies do not provide for the fabrication of parts having a complex shape and sophisticated composition for the custom tailoring of the properties of the parts. Additive manufacturing or 3D printing technology is an enabling technology which does provide for the fabrication of complex shapes, but unfortunately, current additive manufacturing technologies require that the powders with a given composition must be alloyed and made with either plasma or gas atomization techniques prior to their use in the additive manufacturing process.

Given these challenges, methods and apparatuses for additive manufacturing with in situ synthesis of alloys and/or composites from powders with different compositions are needed. The methods and apparatuses of the invention described herein may solve these shortcomings as well as others by proposing a novel method and apparatus for in situ synthesis of alloys and/or composites using different composition powders during three-dimensional additive manufacturing.

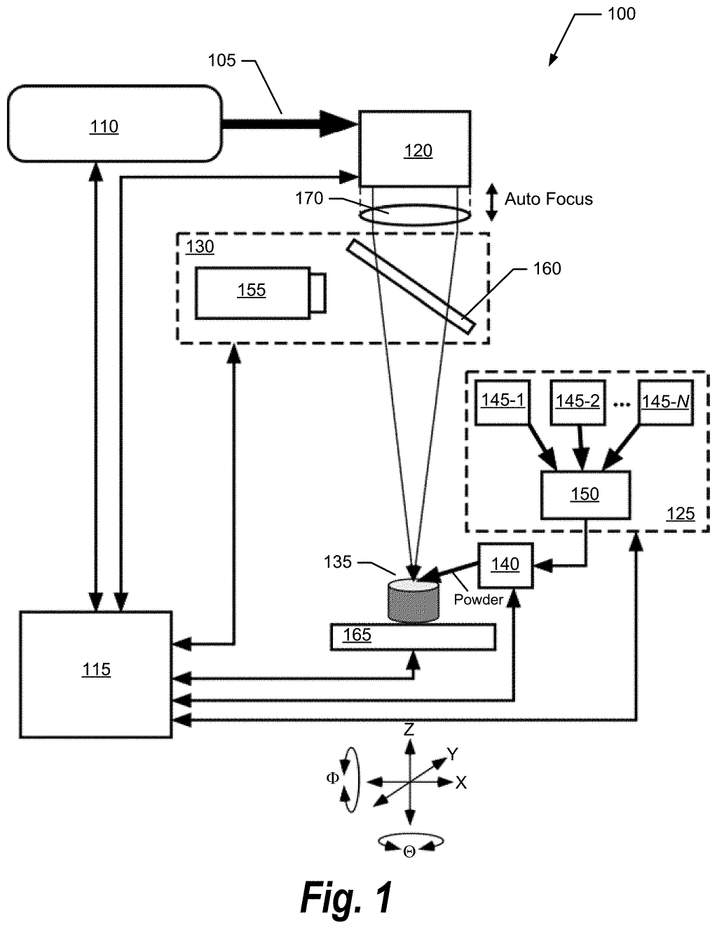

FIG. 1 is a schematic illustration of an apparatus for in situ synthesis of alloys and/or composites using different composition powders during three-dimensional additive manufacturing, in accordance with some embodiments.

In some embodiments, apparatus 100 comprises electromagnetic radiation 105 generated by an electromagnetic energy source 110, a computer 115, an auto focusing scanner 120, a powder system 125, and an inspection system 130. The auto focusing scanner 120 scans and focuses the electromagnetic radiation 105 onto a sample 135 being manufactured from the powder from the powder system 125 being deposited onto the sample 135 by a powder delivery system 140, such as a powder injection nozzle or spreading tank. The powder system 125 comprises N-number of powder vessels having different composition powders 145-1, 145-2, . . . , 145-N, where N is greater than or equal to two, which feed the different composition powders into a powder mixer 150 which mixes the predetermined amounts of each of the N-number of powders based on the desired in situ synthesis of new alloys and composites (such as ceramics, metal matrix composites) during three-dimensional additive manufacturing. In some embodiments, the powder system 125 does not have a powder mixer 150 and the powders are not premixed and instead, the powder from the powder vessels is delivered by the powder delivery system to the sample in an appropriate ratio in order to form metal alloys (high percentage metal) and/or metal matrix composites (high percentage of ceramics) during melting of the additive manufacturing process. The inspection system 130 comprises an imager and processor 155 which monitors the sample 135 (structure, temperature, shape, defects, cracks, roughness, and/or composition of the sample) through a dichroic filter 160 as the sample 135 is being additively manufactured. The scanner 120 may be an acousto-optic type scanner (diffraction), a magnetic resonant scanner, a mechanical scanner (rotating mirror), or an electro-optic scanner, etc. In some embodiments, the sample 135, may be positioned using its own linear and rotary motor stages 165, in X, Y, Z, Θ, and Φ. In some embodiments, the electromagnetic energy source 110 comprises a continuous wave (CW) or pulsed energy source such as an electron beam, a laser, an ultrasonic source, etc. The CW or pulsed energy source may be used in combination with spatial and temporal shaping to manipulate microstructures and mechanical properties at different locations during additive manufacturing (AM) fabrication. In some embodiments, the computer is used to control the electromagnetic energy source 110, to coordinate the scanner 120, to control the powder system 125, to control the inspection system 130, to control the powder delivery system 140, and/or to control the linear and rotary motor stages 165.

In some embodiments, the powder delivery system may be used for four categories of synthesis: (1) multiple metal powder synthesis, (2) metal and ceramic synthesis, (3) ceramic synthesis, and/or (4) gradated composition synthesis during AM fabrication. The general synthesis during AM fabrication begins with materials A plus B to yield materials C and D, where at least one of materials C and D differ in composition and/or phase from materials A and B. Phase is a region of space, throughout which all physical properties of a material are essentially uniform. Examples of physical properties include density, index of refraction, magnetization, microstructure, crystal structure, and chemical composition. In (1) multiple metal powder synthesis, at least two metal powders with different compositions are mixed with an appropriate ratio, either premixed or mixed real time in-situ, and then new phases and/or alloys are synthesized either partially or totally during melting of the additive manufacturing process. In (2) metal and ceramic synthesis, at least one metal powder and at least one ceramic powder with different compositions are mixed, either premixed or mixed real time in-situ, and then new phases, new compounds, and/or alloys are synthesized either partially or totally during melting of the additive manufacturing process. By control of the ratio of mixing, it can form metal alloys (high percentage of metal), metal matrix composites (high percentage of ceramics). It might also generate amorphous single element. For example: Al+B₄C to yield AlB₂ and Al₄C₃. Another example is SiC+Al yields to Al₄C₃ and Si. In (3) ceramic synthesis, at least one non-metal powder and one ceramic powder with different compositions are mixed, either premixed or mixed real time in-situ, and then new phases and/or alloys are synthesized during melting of the additive manufacturing process. Examples of ceramic synthesis comprise mixing ceramic, such as silicon carbide (SiC) or silicone dioxide (SiO2), with another non-metal element, such as carbon (C). For silicon carbide, the synthesis comprises SiC+C to yield SiC+Si. For silicone dioxide, the synthesis comprises SiO2+2C to yield Si and 2CO and SiO2+3C to yield SiC and 2CO. In (4) gradated composition synthesis, metal powder(s) and/or ceramic powder(s) are mixed, either premixed or mixed real time in-situ, and then synthesized during melting to have a gradated material composition during AM fabrication, resulting in a smooth material transition with increased bonding and improved strength. The use of the powder delivery system is not limited to AM with electron beam, laser, ultrasonic electromagnetic energy sources, but may be used with any 3D printing machine.

In some embodiments with a laser electromagnetic energy source, the laser pulse 105 has a tunable pulse repetition rate (PRR) between about 100 kHz and about 1 GHz, an average power from 1 W to 10 kW, a tunable pulse width between about 100 fs to about 10 ns, a maximum output pulse energy of about 500 μJ, and a center wavelength of about 1030 nm to about 1100 nm or other wavelength in the UV-IR (200 nm-2500 nm) spectral region (matching the best material absorption need for the additive manufacturing process and subtractive manufacturing process). The laser can be tuned to work for both additive manufacturing process (layer melting, manipulation of microstructures through tuning of pulse width or spatial shape or temporal shape) and subtractive manufacturing process (trimming of defects and geometrical shapes, hole drilling, surface microstructure modification, surface peening, surface polishing, etc.). In some embodiments, a continuous wave (CW) laser or quasi CW laser can be used. In some embodiments, the computer 115 is first used to convert CAD design to 3D printing procedures and contours. The conversion may also been done on some external computing device that is not part of the apparatus. The computer will be used to process and analyze the data gathered from the inspection system and to feedback to the three-dimensional manufacturing system to adjust the additive manufacturing laser, process, powder mixing, and powder delivery system parameters, such as laser power, pulse width, energy, pulse repetition rate, beam shape, temporal format, scanning speed, hatching space, scanning strategy/pattern, powder thickness, mixed powders etc., before either the next layer is additively manufactured or the current layer is repaired. The computer 115 is used to control the PRR, to control the power of the laser 110, to coordinate the scanner (scan speed, hatching space, scan pattern, focal position) 120, to control the mixing of the powders in the powder system 125, to control the deposition of the powder from the powder delivery system 140, and to control the linear and rotary motorized stages 165. In some embodiments, more than one computer is used to control and monitor. The electromagnetic radiation 105 is coupled into the auto focusing scanner 120 which scans and focuses the laser pulse 105 onto the sample 135 being manufactured from the powder being deposited by the powder delivery system 140, onto the stage at first and then subsequent layers of the sample 135, resulting in a strong weld/bond between the sample and the powder. The focal spot size of the laser pulse may be varied by the focusing lens 170. Beam shaping optics positioned between the laser and the scanner may also be used to modify the beam from Gaussian shape to flat top (square or round). Using a flat top beam shape results in a more uniform processed area than using a Gaussian beam shape, which helps to significantly reduce the non-uniformity of the melting pool and eliminates unmelted powders and thus increases the density and reduces the residual stress of the sample. The sample 135, may be positioned using its own linear and rotary motor stages 165, in X, Y, Z, Θ, and Φ. The inspection system 130 monitors the sample through the dichroic filter 160 as the sample 135 is being additively manufactured. The scanner 120 may be an acousto-optic type scanner (diffraction), a magnetic resonant scanner, a mechanical scanner (rotating mirror), or an electro-optic scanner, etc. An acousto-optic modulator may be used to optimize the laser pulse energy and format of pulses (pulsed modulated control in temporal domain) for melting pool temperature control, which further controls the temperature and cooling rate. A mechanical shutter may also be incorporated into the apparatus for safety. The apparatus is capable of layer-by-layer processing with multiple, different starting materials with micron level precision making complex shapes with fine structures achievable.

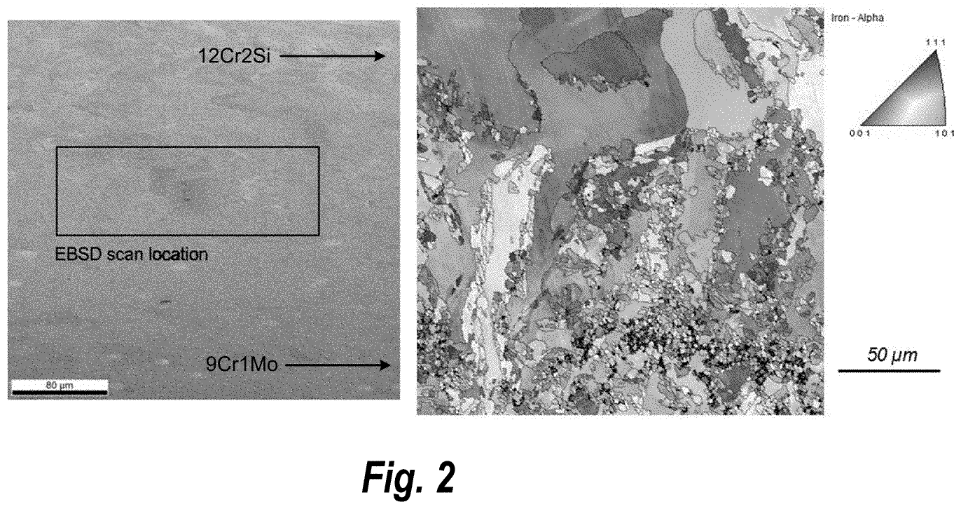

FIG. 2 shows an electron backscatter diffraction of an additively manufactured sample from multiple metal powder synthesis using the apparatus for in situ synthesis of alloys and/or composites of FIG. 1, in accordance with some embodiments.

By utilizing in situ synthesis of alloys and/or composites using different composition metal powders during three-dimensional additive manufacturing, various types of shapes and multi-metallic structures may be fabricated to fit to various applications. In one embodiment, a bimetallic structure having 9Cr1Mo steel-12Cr2Si steel (category 1) may be fabricated to have high temperature strength and Lead-Bismuth eutectic (LBE) corrosion resistance for the nuclear reactor industry. By mixing two different metal powders of 9Cr1Mo steel and 12Cr2Si steel during AM fabrication, a smooth and strong bond may be formed in the transition region. The electron backscatter diffraction (EBSD) of FIG. 2 shows that an excellent phase transition and very strong bonding were formed between the 9Cr1Mo steel and 12Cr2Si steel to produce a new 9Cr1Mo steel-12Cr2Si alloy steel. This new alloy has new material properties, such as mechanical, chemical, physical, and electrical, which differ from the material properties of the initial metal powders of 9Cr1Mo steel and 12Cr2Si steel.

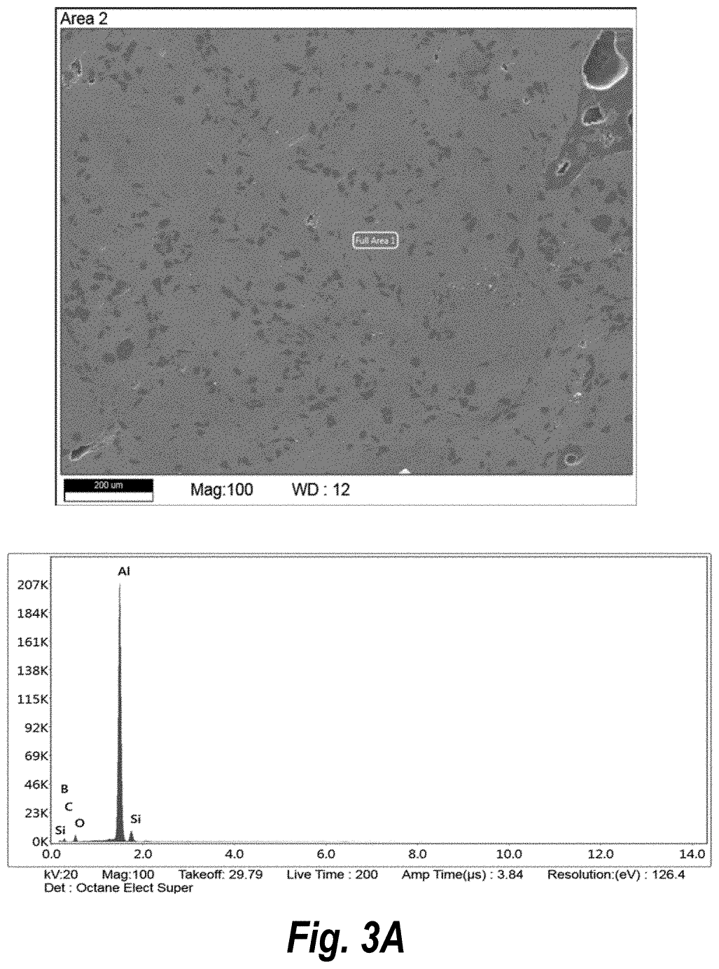

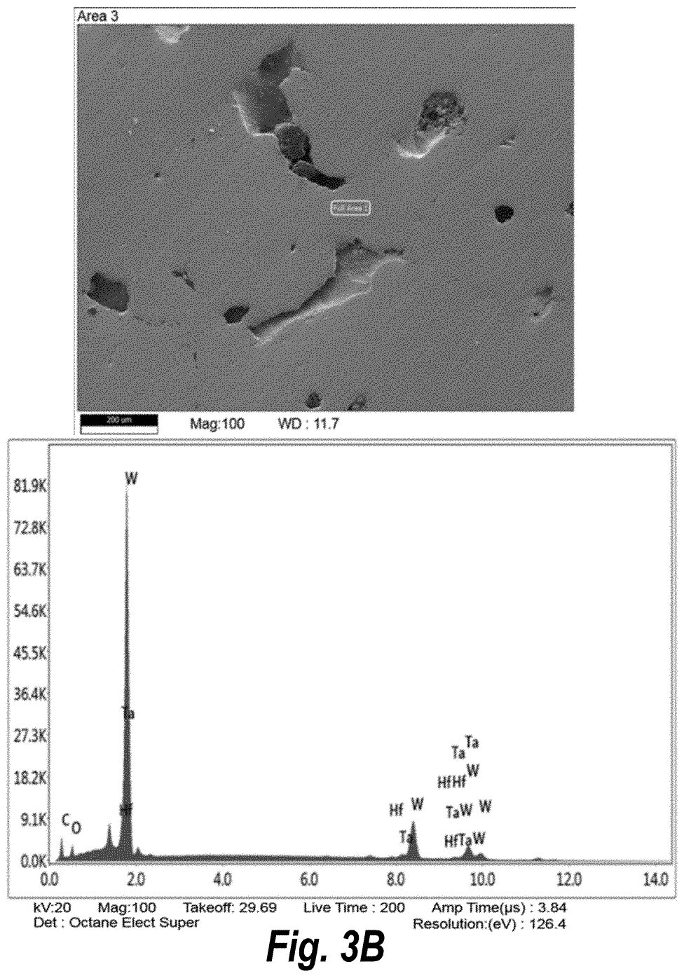

FIGS. 3A and 3B show scanning electron microscopy images and energy-dispersive X-ray spectroscopy composition spectrums of additively manufactured samples using in situ metal and ceramic synthesis of alloys and composites of aluminum/boron carbon powder mixture and tungsten/hafnium tantalum carbide powder mixture, respectively, in accordance with some embodiments.

By utilizing in situ synthesis of alloys and/or composites using different composition metal and ceramic powders during three-dimensional additive manufacturing, the manufactured structures may be reinforced by the formation of new metal matrix composites (MMCs). For example, highly porous MMC preforms may be infiltrated by molten metal when casting light-weight engine block components, resulting in seamless transitions between metal and ceramic in these components. FIG. 3A shows a scanning electron microscopy (SEM) image and its corresponding energy-dispersive X-ray spectroscopy (EDS) composition spectrum from an aluminum/boron carbon synthesis from starting powders of boron carbide (B₄C) and an aluminum powder or aluminum alloy such as AL7075 or 6061 or AlSi₁₀Mg. FIG. 3B shows an SEM image and its corresponding EDS composition spectrum from a tungsten/hafnium tantalum carbide synthesis from starting powders of 10% by weight of hafnium tantalum carbide (HfTaC) and 90% by weight of tungsten (W).

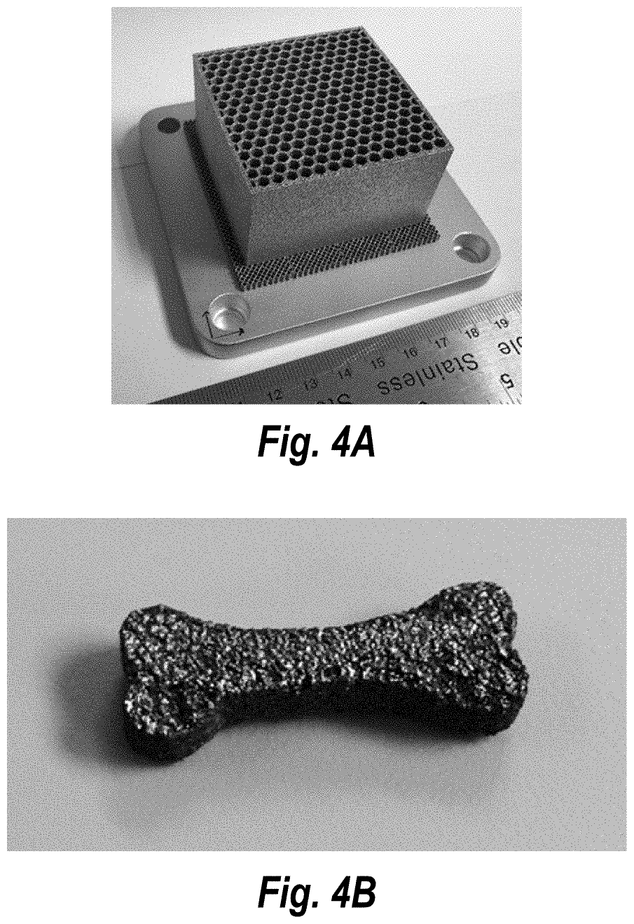

FIGS. 4A and 4B show additively manufactured sample parts using in situ metal and ceramic synthesis of alloys and composites of aluminum/boron carbon powder mixture and tungsten/hafnium tantalum carbide powder mixture, respectively, in accordance with some embodiments.

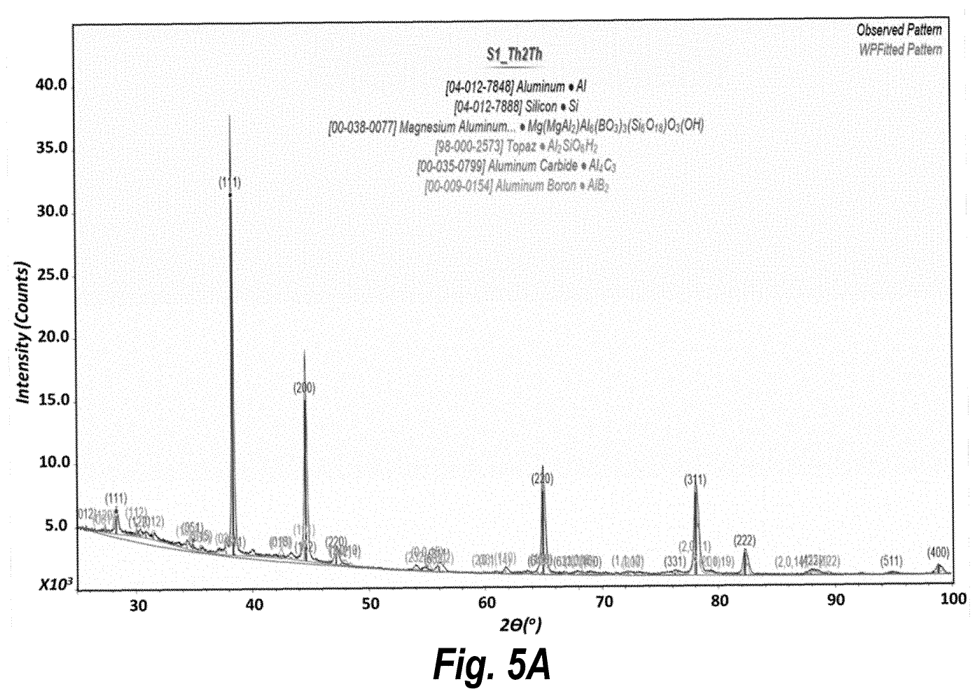

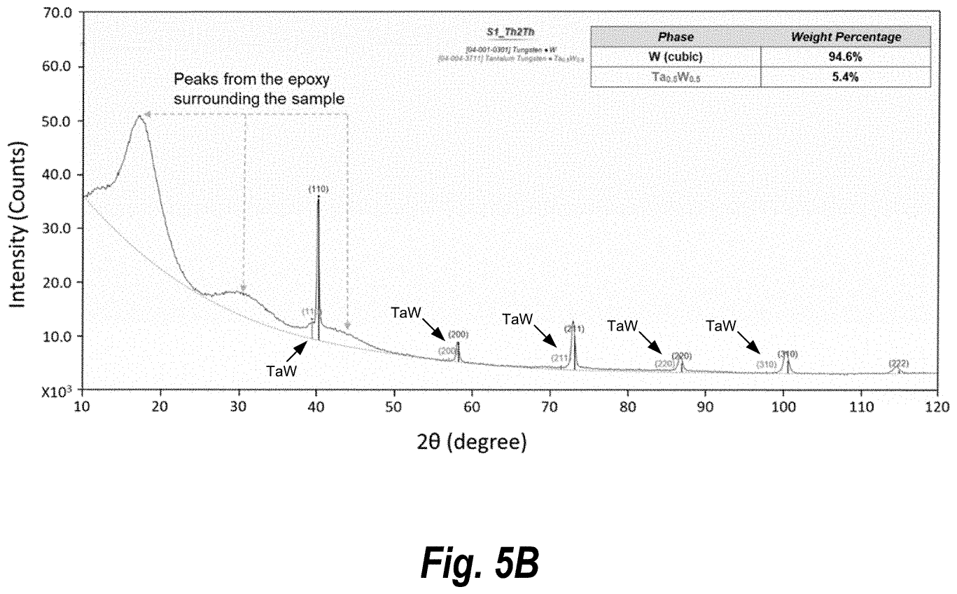

FIGS. 5A and 5B show X-ray powder diffraction data of additively manufactured sample parts using in situ metal and ceramic synthesis of alloys and composites of aluminum/boron carbon powder mixture and tungsten/hafnium tantalum carbide powder mixture, respectively, using the apparatus of FIG. 1, in accordance with some embodiments.

By utilizing in situ synthesis of alloys and/or composites using different composition metal and ceramic powders during three-dimensional additive manufacturing, the manufactured structures may be reinforced by the formation of new MMCs which have different material properties (mechanical, chemical, physical, electrical, etc.) from the initial materials. FIG. 4A shows a honeycomb structure additively manufactured with 20% of boron carbon and 80% of aluminum powders. The honeycomb structure shows a very high density of 98% as a result of the good melting and synthesis between the ceramic and metal powders during the additive manufacturing which formed the new MMCs. The X-ray powder diffraction data, shown in FIG. 5A, clearly shows newly formed crystal phases of aluminum carbide (Al₄C₃) and aluminum diboride (AlB₂) formed during the melting and solidification of the additive manufacturing process from the in situ synthesis from the different initial composition powders. FIG. 4B shows a dog bone structure additively manufactured with 10% tantalum hafnium carbide (TaC-HfC) (4:1) powder and 90% of tungsten powder. The X-ray powder diffraction data, shown in FIG. 5B, clearly shows that new alloys, such as TaW, are formed during the melting and solidification of the additive manufacturing process from the in situ synthesis from the different initial composition tungsten/hafnium tantalum carbide powder mixture.

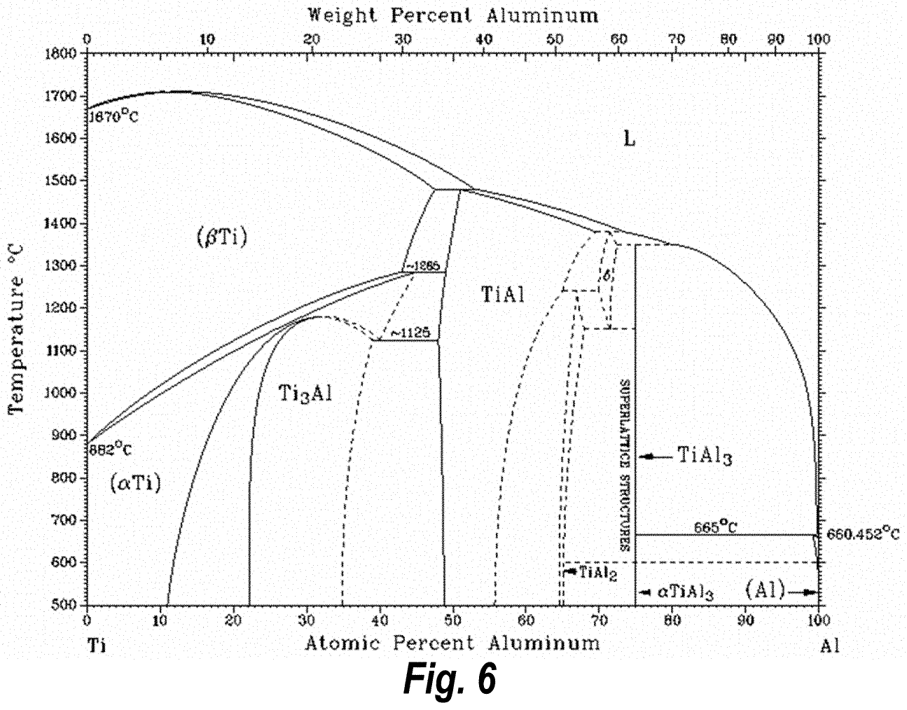

FIG. 6 shows a phase transition diagram of titanium and aluminum, in accordance with some embodiments.

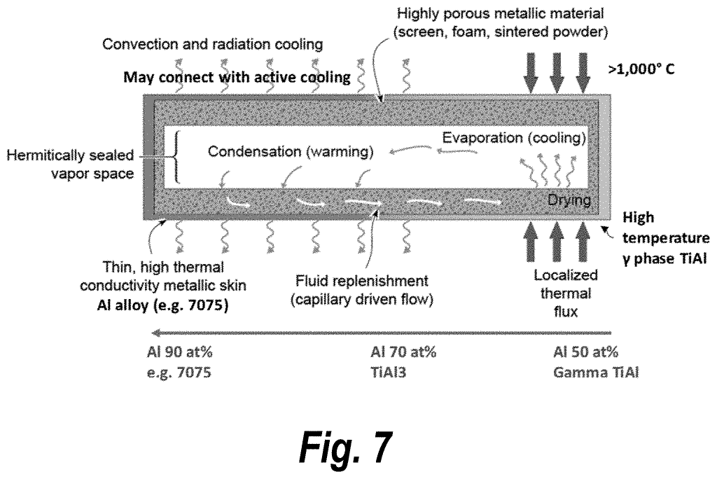

FIG. 7 is a schematic illustration of an integral heat pipe with gradated composition, in accordance with some embodiments.

Since aerodynamic friction produces external structure temperatures above 1,000° C., hypersonic aircraft must be streamlined for low drag and heating of the internal surfaces of propulsion structures necessitates their cooling. Thus, significant advances in materials and in their manufacturing processes are required to produce low mass and high performance structures incorporating cooling passages or integral heat pipes for thermal management. Current heat transfer devices include complex shapes of pipes, heat exchangers, inlets, and outlets which experience large temperature gradients. These heat transfer devices require tedious processes to insert the porous wick into the evaporator and integrate tens of discrete components. Reducing the cost and skill required to manufacture integrated heat transfer devices for pumped fluid loops is desired in order to increase heat transfer performance. The use of innovative materials achievable through the synthesis of new alloys and composites using the apparatus disclosed in FIG. 1, along with a reduction of machining, multiple setups, and labor hours, makes this possible. FIG. 7 illustrates an integral heat pipe with gradated composition which may be AM fabricated using (category 4) gradated composition synthesis.

One such material for these high performance heat pipes is gamma titanium aluminide which shows excellent properties in high temperature operation (>1,000° C.) and is resistant to high temperature oxidation. Gamma titanium aluminides have been used in the aerospace industry to make engines. The γ phase for gamma titanium aluminides exists between 48 atomic percent (at %) and 69.5 at % Al as shown in FIG. 6 and when the composition is off-stoichiometric, the excess Ti or Al atoms are placed as anti-site atoms without creation of vacancies. Moreover, by tuning the Al concentration, gamma titanium aluminides can match with different materials having different coefficients of thermal expansion (gamma TiAl at the high temperature region, then gradually transition to lower temperature region with increasing Al content) as illustrated in FIG. 6. This makes the heat pipe more lightweight and more compatible with other Al alloys, such as Al7075 or Al 6061. As shown in FIG. 7, the heat pipe has a gradated composition ranging from the gamma titanium aluminide high temperature end having a 50 at % of Al to an aluminum alloy having a 90 at % of Al at the opposite end.

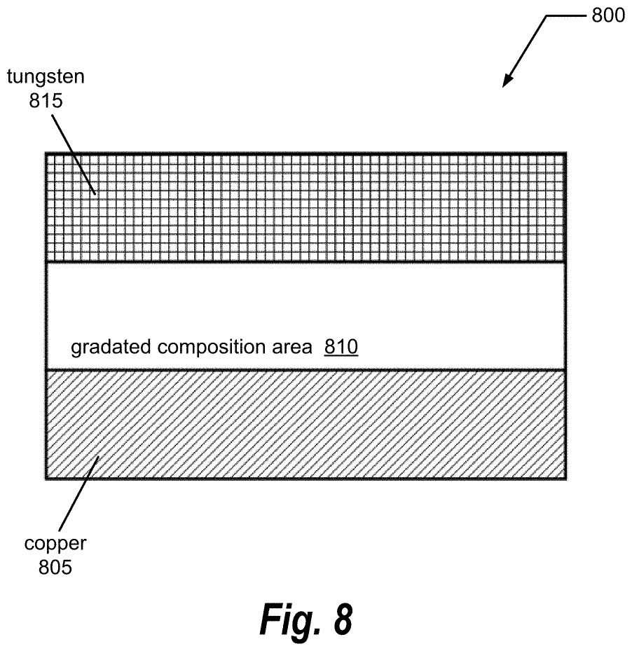

FIG. 8 is a schematic illustration of gradated layer area formed between tungsten and copper, in accordance with some embodiments.

In some embodiments, the method and apparatus for in situ synthesis of alloys and/or composites from different composition powders during additive manufacturing may be used to form a sample 800 where tungsten is bound to copper (category 4). In such an embodiment, starting with a copper substrate 805, powders of tungsten and copper, with an increasing ratio of tungsten between the two, are delivered into the region of the focused and scanned electromagnetic radiation to form a gradated composition area 810 from layer to layer until only 100% tungsten 815 is formed at the top of the sample. Thus in the gradated composition area 810 of the formed sample 800, the percentage of tungsten decreases from 100% at the tungsten 815 top interface to 0% at the copper 805 bottom interface.

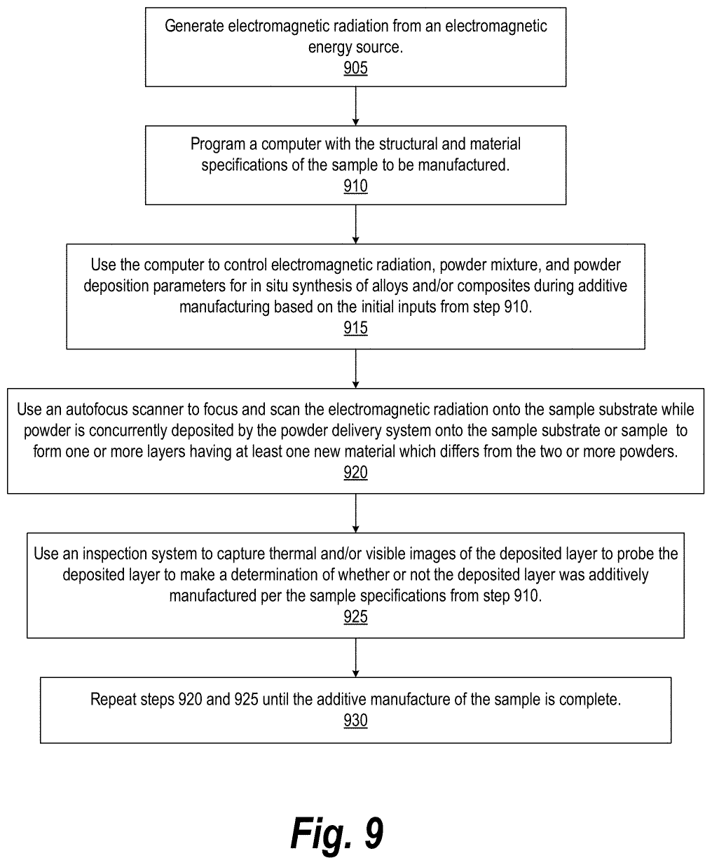

FIG. 9 is a block diagram illustrating a method for in situ synthesis of alloys and/or composites using different composition powders in three-dimensional manufacturing, in accordance with some embodiments.

In some embodiments, processing begins at step 905 where an electromagnetic energy source is used to generate electromagnetic radiation which matches the material absorption of the two or more different powders to be used for the additive manufacturing process. At step 910, a computer is programmed with the structural and material specifications of the sample to be manufactured. Next, at step 915, the computer controls the electromagnetic radiation, powder mixture, and powder deposition parameters for in situ synthesis of alloys and/or composites during additive manufacturing based on the initial inputs from step 910. At step 920, using an autofocusing scanner, the electromagnetic radiation is focused and scanned onto the sample substrate while powder is concurrently deposited by the powder delivery system onto the sample substrate to form one or more layers having at least one new material which differs from the two or more powders. In subsequent layers, the electromagnetic radiation is focused and scanned onto the previously deposited layer of the sample. In some embodiments, processing continues to step 925, where a determination is made of whether or not the just deposited layer was additively manufactured per the sample structural and material specifications from step 910 by capturing images (thermal images and/or visible images) of the additively manufactured sample with an inspection system. At step 930, steps 915 and 920 are repeated until the additive manufacture of the sample is complete. In some embodiments, the method further comprises a step between step 925 and step 930 where the one or more computers are used to adjust the electromagnetic energy source, the powder system, and/or the powder delivery system based on the determination made in step 925 prior to either additively manufacturing a subsequent layer onto the sample or making repairs to the deposited layer. Although the flowchart may describe the operations as a sequential process, the operations may be performed in parallel or concurrently. In addition, the order of the operations may be rearranged.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for in situ synthesis of alloys and/or composites from two or more powders in additive manufacturing comprising:
(a) providing an apparatus having:
an electromagnetic energy source configured to generate electromagnetic radiation;
an autofocusing scanner configured to receive the electromagnetic radiation from the electromagnetic energy source and to focus and scan the electromagnetic radiation onto a stage where a sample is additively manufactured;
a powder system comprising N powder vessels for the two or more powders;
a powder delivery system configured to receive the two or more powders from the powder system and to deposit the two or more powders onto the stage in the vicinity of the focused and scanned electromagnetic radiation; and
one or more computers coupled to the electromagnetic energy source, the autofocusing scanner, the powder system, and the powder delivery system and configured to control the electromagnetic energy source, the autofocusing scanner, the powder system, and the powder delivery system;
(b) programming the one or more computers with structural and material specifications of the sample to be additively manufactured;
(c) using the one or more computers to control electromagnetic radiation, powder mixture, and powder deposition parameters based on the structural and material specifications of the sample programmed into the one or more computers; and
(d) using the autofocusing scanner to focus and scan the electromagnetic radiation onto the sample while the two or more powders are concurrently deposited by the powder delivery system onto the sample in order to deposit one or more layers onto the sample for multiple metal powder synthesis, metal and ceramic synthesis, ceramic synthesis, and/or gradated composition synthesis, wherein the one or more layers comprise at least one new material which differs from the two or more powders.

2. The method of claim 1, wherein the multiple metal powder synthesis, the metal and ceramic synthesis, the ceramic synthesis, and/or the gradated composition synthesis may be either partially or totally reacted to form the at least one new material.

3. The method of claim 1, wherein the at least one new material comprises a different compound from the two or more powders.

4. The method of claim 1, wherein the at least one new material comprises at least one of a different crystal structure or a different phase from the two or more powders.

5. The method of claim 1, wherein the at least one new material comprises a metal alloy of the two or more powders.

6. The method of claim 1, wherein the at least one new material comprises a metal matrix composite of the two or more powders.

7. The method of claim 1, wherein the powder system further comprises:
a powder mixer configured to receive and mix a predetermined amount of each of the two or more powders from the N powder vessels prior to sending to the powder delivery system.

8. The method of claim 1, wherein for the multiple metal powder synthesis, the two or more powders comprise two or more metal powders.

9. The method of claim 8, wherein the two or more metal powders comprise B₄C and Al to synthesize aluminum carbide and aluminum diboride.

10. The method of claim 1, wherein for the metal and ceramic synthesis, the two or more powders comprise one or more metal powders and one or more ceramic powders.

11. The method of claim 10, wherein one of the one or more metal powders comprises tungsten and wherein one of the one or more ceramic powders comprises tantalum hafnium carbide to synthesize TaW.

12. The method of claim 1, wherein for the ceramic synthesis, the two or more powders comprise one or more ceramic powders and one or more non-metal powders.

13. The method of claim 12, wherein the one of the one or more ceramic powders comprises silicon carbide or silicon dioxide and wherein the one or more non-metal powders comprises carbon.

14. The method of claim 13, wherein the silicon carbide may be formed in the one or more layers.

15. The method of claim 1, wherein the one or more layers comprises a gradated material composition from layer to layer to form a smooth transition of dissimilar two or more powders.

16. The method of claim 15, wherein the gradated material composition from layer to layer of the smooth transition comprises gradation from gamma titanium aluminides to Al.

17. The method of claim 15, wherein the gradated material composition from layer to layer of the smooth transition comprises gradation from tungsten to copper.

18. The method of claim 1, wherein the electromagnetic energy source comprises an electron beam, a laser, and/or an ultrasonic source.

19. The method of claim 18, wherein the laser comprises a CW or pulsed fiber laser and an acousto-optic modulator configured to control temporal format.

20. The method of claim 1, wherein the electromagnetic radiation comprises a wavelength between about 200 nm to about 2500 nm.

21. An apparatus for in situ synthesis of alloys and/or composites using two or more powders in additive manufacturing comprising:
an electromagnetic energy source configured to generate electromagnetic radiation;
an autofocusing scanner configured to receive the electromagnetic radiation from the electromagnetic energy source and to focus and scan the electromagnetic radiation onto a stage where a sample is additively manufactured;
a powder system comprising N powder vessels for the two or more powders;
a powder delivery system configured to receive the two or more powders from the powder system and to deposit the two or more powders onto the stage in the vicinity of the focused and scanned electromagnetic radiation; and
one or more computers coupled to the electromagnetic energy source, the autofocusing scanner, the powder system, and the powder delivery system and configured to control the electromagnetic energy source, the autofocusing scanner, the powder system, and the powder delivery system to deposit one or more layers of the sample for multiple metal powder synthesis, metal and ceramic synthesis, ceramic synthesis, and/or gradated composition synthesis, wherein the one or more layers comprise at least one new material which differs from the two or more powders.

22. The apparatus of claim 21, wherein the multiple metal powder synthesis, the metal and ceramic synthesis, the ceramic synthesis, and/or the gradated composition synthesis may be either partially or totally reacted to form the at least one new material.

23. The apparatus of claim 21, wherein the at least one new material comprises a different compound from the two or more powders.

24. The apparatus of claim 21, wherein the at least one new material comprises at least one of a different crystal structure or a different phase from the two or more powders.

25. The apparatus of claim 21, wherein the at least one new material comprises a metal alloy of the two or more powders.

26. The apparatus of claim 21, wherein the at least one new material comprises a metal matrix composite of the two or more powders.

27. The apparatus of claim 21, wherein the powder system further comprises:
a powder mixer configured to receive and mix a predetermined amount of each of the two or more powders from the N powder vessels prior to sending to the powder delivery system.

28. The apparatus of claim 21, wherein for the multiple metal powder synthesis, the two or more powders comprise two or more metal powders.

29. The apparatus of claim 28, wherein the two or more metal powders comprise B₄C and Al to synthesize aluminum carbide and aluminum diboride.

30. The apparatus of claim 21, wherein for the metal and ceramic synthesis, the two or more powders comprise one or more metal powders and one or more ceramic powders.

31. The apparatus of claim 30, wherein one of the one or more metal powders comprises tungsten and wherein one of the one or more ceramic powders comprises tantalum hafnium carbide to synthesize TaW.

32. The apparatus of claim 21, wherein for the ceramic synthesis, the two or more powders comprise one or more ceramic powders and one or more non-metal powders.

33. The apparatus of claim 32, wherein the one of the one or more ceramic powders comprises silicon carbide or silicon dioxide and wherein the one or more non-metal powders comprises carbon.

34. The apparatus of claim 33, wherein the silicon carbide may be formed in the one or more layers.

35. The apparatus of claim 21, wherein the one or more layers comprises a gradated material composition from layer to layer to form a smooth transition of dissimilar two or more powders.

36. The apparatus of claim 35, wherein the gradated material composition from layer to layer of the smooth transition comprises gradation from gamma titanium aluminides to Al.

37. The apparatus of claim 35, wherein the gradated material composition from layer to layer of the smooth transition comprises gradation from tungsten to copper.

38. The apparatus of claim 21, wherein the electromagnetic energy source comprises an electron beam, a laser, and/or an ultrasonic source.

39. The apparatus of claim 38, wherein the laser comprises a CW or pulsed fiber laser and an acousto-optic modulator configured to control temporal format.

40. The apparatus of claim 21, wherein the electromagnetic radiation comprises a wavelength between about 200 nm to about 2500 nm.
